(19) United States
(12) Patent Application Publication
(10) Pub. No.: US 2024/0343650 A1
(43) Pub. Date: Oct. 17, 2024

(54) PHOSPHOGYPSUM-BASED BACKFILL MATERIAL AND PREPARATION METHOD THEREOF

(71) Applicant: Jin Hu, Chengdu City (CN)

(72) Inventor: Jin Hu, Chengdu City (CN)

(21) Appl. No.: 18/625,931

(22) Filed: Apr. 3, 2024

(30) Foreign Application Priority Data
Apr. 13, 2023 (CN) 202310393635.1

(51) Int. Cl. C04B 28/14; C04B 14/06; C04B 14/48; C04B 18/08; C04B 111/00

(52) U.S. Cl. CPC C04B 28/143; C04B 14/06; C04B 14/48; C04B 18/08; C04B 2111/00663

(57) ABSTRACT

Disclosed is a phosphogypsum-based backfill material, including the following components in parts by weight: 0.2-0.8 parts of water, 0.01-0.3 parts of a cement, 0.01-0.6 parts of a fly ash, 0-0.6 parts of a stone powder, 0-3 parts of a sand, and 0-5 parts of a stone; and further including the following components in parts by weight: 1 part of any one or a combination of two or more selected from the group consisting of phosphogypsum, a modified phosphogypsum, and a modified phosphogypsum powder, and 0-0.5 parts of any one selected from the group consisting of a basalt fiber, graphite, and a steel fiber.

### CROSS REFERENCE TO RELATED APPLICATION

This patent application claims the benefit and priority of Chinese Patent Application No. 202310393635.1 filed with the China National Intellectual Property Administration on Apr. 13, 2023, the disclosure of which is incorporated by reference herein in its entirety as part of the present application.

### TECHNICAL FIELD

The present disclosure relates to the technical field of backfill materials, and specifically to a phosphogypsum-based backfill material and a preparation method thereof.

### BACKGROUND

Phosphogypsum is an industrial by-product during a production process of wet-process phosphoric acid, where a phosphate rock (a main component of the phosphate rock is calcium fluorophosphate 3Ca(PO4)₂·CaF₂) is decomposed with sulfuric acid to produce a phosphoric acid solution and a calcium sulfate precipitate, and 4.5 t to 5.0 t of phosphogypsum (expressed as dry-basis dihydrate gypsum) can be produced as a by-product per ton of P₂O₅.

Currently, only 15% of phosphogypsum is utilized for soil improvement, cement manufacturing, and civil engineering materials, while the remaining about 85% of phosphogypsum is discarded into oceans or rivers or is stored in ponds or dumped on site without purification. Untreated phosphogypsum includes many impurities such as soluble acids (HF, sulfuric acid, and phosphoric acid), salts, radioactive substances, and organic matters, and these impurities can penetrate into soil and water, causing serious environmental damages (chemical pollution and radioactive pollution). How to comprehensively utilize phosphogypsum is an urgent problem to be solved.

Backfill materials are often used in building construction processes. Phosphogypsum has been directly used to prepare a mortar or a plate as a backfill material, but phosphogypsum has a low strength and poor durability and is slightly soluble in acid. Phosphogypsum has also be modified with a cement-based material and then prepared into a mortar for backfilling.

Phosphogypsum modified merely with a cement-based material has an improved strength, but will lead to generation of calcium sulfoaluminate hydrate, which has expansibility causing cracking and is easy to cause cracking. In addition, harmful substances will be leached out under an action of water, resulting in environmental hazards.

### SUMMARY

A technical problem to be solved by the present disclosure is that phosphogypsum has a low strength when recycled to be used as a backfill material, or is easy to crack when mixed with a cement-based material, resulting in environmental hazards. The present disclosure is intended to provide a phosphogypsum-based backfill material and a preparation method thereof.

A first object of the present disclosure is to provide a phosphogypsum-based backfill material, including the following raw materials in parts by weight: 0.2-0.8 parts of water, 0.01-0.3 parts of a cement, 0.01-0.6 parts of a fly ash, 0-0.6 parts of a stone powder, 0-3 parts of a sand, and 0-5 parts of a stone; and
further including the following raw materials in parts by weight:
1 part of any one or a combination of two or more selected from the group consisting of phosphogypsum, a modified phosphogypsum, and a modified phosphogypsum powder; and
0-0.5 parts of any one selected from the group consisting of a basalt fiber, graphite, and a steel fiber.

In some embodiments of the present disclosure, a main component of the stone powder is calcium carbonate. In some embodiments of the present disclosure, the stone powder includes one or more selected from the group consisting of a limestone powder, a marble powder, and a white marble powder.

In the present disclosure, constituent materials are selected and a reasonable ratio thereof is designed; the phosphogypsum is adopted as a base material, and mixed with the cement, a limestone powder, and the fly ash. C3S\C2S\C3A\C4AF is produced based on a hydration reaction of the cement, a calcium carboaluminate hydrate is produced based on filling and chemical actions of the limestone powder, the instability of the calcium carboaluminate hydrate is reduced based on a chemical reaction of the fly ash, and the basalt fiber, graphite, steel fiber, or other fiber is used to enhance toughness, so as to obtain a product with desired strength and desired environmental safety. The product has a stable structure, a high strength, and excellent durability, can meet environmental safety requirements, and overcomes the cracking problem caused by mixing of phosphogypsum and cement. In the phosphogypsum-based backfill material, leached amounts of heavy metal ions, phosphorus, and fluorine meet environmental requirements. The backfill material has a strength of 0.1 MPa to 30 MPa and is suitable for a variety of backfill scenarios. Moreover, in the same backfill scenario, the backfill material has a significantly higher strength than the existing materials of the same type. A raw material ratio can be adjusted according to different use scenarios to obtain materials with different strengths suitable for a wide range of scenarios. The phosphogypsum-based backfill material has qualified environmental safety. In addition, chemical solid waste phosphogypsum and a mine solid waste stone powder are used as raw materials to improve the resource utilization, reduce the pollution for underground space, especially water, and reduce the cost of backfill detection and the energy consumption.

In an optional embodiment, the basalt fiber, the graphite, or the steel fiber has a length of less than or equal to 50 mm.

In an optional embodiment, a mass ratio of the water to (the cement+the modified phosphogypsum+the modified phosphogypsum powder) or a mass ratio of the water to (the cement+the fly ash+the stone powder) is less than or equal to 0.5 and is preferably 0.4.

The inventors have found through research that the above mentioned mass ratios can result in that the prepared backfill material have excellent working performance, a desired strength, and desired environmental safety.

In an optional embodiment, a mass of the steel fiber or the basalt fiber is 10% to 20% of a mass of the phosphogypsum or the modified phosphogypsum, and a mass ratio of the fly ash to the cement is in a range of (1-3):1.

The inventors have found through research that an amount of the cement plays an important role in the whole reaction system. In some embodiments of the present disclosure, a mass of the cement is 5% to 15% of a total mass of the modified phosphogypsum or the phosphogypsum and the stone powder, and with this ratio, the prepared backfill material has a desired strength and desired environmental safety. If the mass of the cement is less than 5% of the total mass of the modified phosphogypsum or the phosphogypsum and the stone powder, the environmental safety and strength will be not high. If the mass of the cement is more than 15% of the total mass of the modified phosphogypsum or the phosphogypsum and the stone powder, it will cause cracking.

Similarly, if a mass of the steel fiber or the basalt fiber is less than 10% of a mass of the phosphogypsum or the modified phosphogypsum, it will lead to insufficient toughness. No fiber can be added when high tensile properties are not required. If the mass of the steel fiber or the basalt fiber is more than 20% of the mass of the phosphogypsum or the modified phosphogypsum, it will lead to poor working performance due to difficult stirring.

Under the condition that the mass ratio of the fly ash to the cement is in a range of (1-3):1, the stability of the prepared backfill material can be improved. If the mass ratio of the fly ash to the cement is less than 1:1 or greater than 3:1, the environmental safety and strength will be insufficient.

In an optional embodiment, the cement is a portland cement.

In an optional embodiment, a fineness degree and a specific surface area of the fly ash meet grade I and II requirements in a fly ash specification (“Fly ash used for cement and concrete (GB/T 1596-2017)”).

In an optional embodiment, the stone powder has a particle size D90 of 25 μm to 150 μm.

A second object of the present disclosure is to provide a method for preparing the phosphogypsum-based backfill material as described above, including:
adding the raw materials to a grout stirring device according to the formula, and thoroughly stirring.

In an optional embodiment, the stirring is conducted for 1 min to 6 min at a rotational speed of 48 rpm. Alternatively, the stirring is conducted for corresponding times at other equivalent rotational speeds. The above stirring conditions can allow a thorough stirring effect.

A too-long stirring time is easy to cause segregation.

Compared with the prior art, some embodiments of the present disclosure have the following advantages and beneficial effects:

(1) In the present disclosure, a solid waste phosphogypsum-based material and a stone powder are utilized, which improves the resource utilization, reduces the pollution for underground space, especially water, and reduces the cost of backfill detection and the energy consumption.

(2) In the present disclosure, constituent materials in a novel solid waste-based backfill material and a ratio thereof are cleverly utilized, such that phosphogypsum can be used while solving the problem that phosphogypsum exhibits poor service performance due to unsatisfactory environmental safety, low physical strength, poor durability, and easy cracking.

(3) In the present disclosure, an electric resistivity is changed by using different fibers, and the distinction between a backfill material and an original rock and soil is allowed according to different electric resistivity values at different ratios, which facilitates the performance detection of a backfill material and can allow the on site detection (an embedded probe) without collecting a sample through drilling.

### DETAILED DESCRIPTION OF THE EMBODIMENTS

In order to make the objects, technical solutions, and advantages of the present disclosure apparent, the present disclosure will be further described in detail below with reference to examples. The exemplary examples and descriptions thereof in the present disclosure are merely used to explain the present disclosure, and are not intended to limit the present disclosure.

Each phosphogypsum-based backfill material was prepared as follows: according to a formula of each example in the following table, raw materials were fed into a grout stirring device and thoroughly stirred for 1 min to 6 min at a rotational speed of 48 rpm. The formula of each example is shown in Table 1 below, and each raw material in Table 1 is listed in a unit of g.

TABLE 1
Formula of each example

| | | | Modified | | | | | |
|---|---|---|---|---|---|---|---|---|
| | | | phosphor- | | | | | |
| | | | gypsum/ | | | | | |
| | | | modified | | | | | |
| Test | | | phosphor- | | | | | |
| block | | | gypsum | | Stone | Steel | | |
| No. | Water | Cement | powder | Fly ash | powder | fiber | Sand | Stone |
| Ex. 1 | 2700 | 1060 | 2250/0 | 2025 | 0 | 210 | 10350 | 0 |
| Ex. 2 | 2700 | 1060 | 2250/0 | 2025 | 50 | 210 | 10350 | 0 |
| Ex. 3 | 160 | 240 | 5/0 | 152 | 8 | 0 | 772.8 | 1067 |
| Ex. 4 | 160 | 240 | 5/0 | 136 | 24 | 0 | 772.8 | 1067 |
| Ex. 5 | 2700 | 1030 | 2250/0 | 2025 | 805 | 105 | 10350 | 0 |
| Ex. 6 | 2700 | 1030 | 2250/0 | 2025 | 1005 | 105 | 10350 | 0 |
| Ex. 7 | 160 | 204 | 36/0 | 152 | 8 | 105 | 772.8 | 1067 |
| Ex. 8 | 160 | 36 | 204/0 | 152 | 8 | 105 | 772.8 | 1067 |
| Ex. 9 | 2475 | 1080 | 2250/0 | 2025 | 900 | 113 | 10350 | 0 |
| Ex. 10 | 2475 | 1080 | 2250/0 | 2025 | 900 | 49.6 | 10350 | 0 |
| Ex. 11 | 2475 | 1080 | 4275/0 | 0 | 0 | 49.6 | 10350 | 0 |

Products of the above examples each were tested, and specific test results are shown in Table 2 below.

Test methods were as follows:

Compressive strength test: A mortar obtained in each example and comparative example was placed in a mold to obtain a test block with a size of 70.7*70.7*70.7 (length*width*height, mm). According to the standard JGJ/T 70-2009, a compression testing machine NYL-300 (005) was used to allow the compressive strength test.

Solid waste leaching test: According to the “Horizontal Oscillation Method-Leaching Method for Leaching Toxicity of Solid Wastes (HJ 557-2010)”, a leaching solution was prepared and tested for cadmium, mercury, arsenic, lead, chromium, a fluoride, and total phosphorus.

TABLE 2
Test results for each example

| | Comp. | | | | | | | | |
|---|---|---|---|---|---|---|---|---|---|
| | Strength | Cd | Hg | As | Pb | Cr | F⁻ | Total P | Electric |
| No. | (MPa) | (mg/L) | (mg/L) | (mg/L) | (mg/L) | (mg/L) | (mg/L) | (mg/L) | Resistivity |
| Ex. 1 | 1.5058 | <0.0012 | <0.00009 | <0.0003 | <0.0042 | <0.0038 | <0.84 | <0.01 | 0.47 |
| Ex. 2 | 1.9373 | <0.0012 | <0.00009 | <0.0003 | <0.0042 | <0.0038 | <0.84 | <0.01 | 0.58 |
| Ex. 3 | 35.4253 | <0.0012 | <0.00009 | <0.0003 | <0.0042 | <0.0038 | <0.84 | <0.01 | 1.25 |
| Ex. 4 | 29.6117 | <0.0012 | <0.00009 | <0.0003 | <0.0042 | <0.0038 | <0.84 | <0.01 | 1.11 |
| Ex. 5 | 3.7143 | <0.0012 | <0.00009 | <0.0003 | <0.0042 | <0.0038 | <0.84 | <0.01 | 0.62 |
| Ex. 6 | 4.4268 | <0.0012 | <0.00009 | <0.0003 | <0.0042 | <0.0038 | <0.84 | <0.01 | 0.63 |
| Ex. 7 | 24.9607 | <0.0012 | <0.00009 | <0.0003 | <0.0042 | <0.0038 | <0.84 | <0.01 | 1.06 |
| Ex. 8 | 15.395 | <0.0012 | <0.00009 | <0.0003 | <0.0042 | <0.0038 | <0.84 | <0.01 | 0.76 |
| Ex. 9 | 6.4380 | <0.0012 | <0.00009 | <0.0003 | <0.0042 | <0.0038 | <0.84 | <0.01 | 0.7 |
| Ex. 10 | 3.6631 | <0.0012 | <0.00009 | <0.0003 | <0.0042 | <0.0038 | <0.84 | <0.01 | 0.6 |
| Ex. 11 | 1.5 | >0.0012 | >0.00009 | >>0.0003 | >0.0042 | >0.0038 | >0.84 | >0.01 | 0.46 |

It can be seen from Examples 1 to 11 that the backfill material of the present disclosure has a strength of 0.1 MPa to 30 MPa or more, and does not have cracks. In the solid waste leaching test, leached amounts of heavy metal ions, phosphorus, and fluorine all meet environmental requirements, indicating that the immobilization of harmful heavy metal ions, phosphorus, and fluorine in each material is completed. The obtained materials have an electric resistivity of 0.35 to 2.67, and the electric resistivity is changed to allow distinction between a backfill material and an original rock and soil, which facilitates the performance detection of a backfill material and can allow the on site detection (an embedded probe) without collecting a sample through drilling. In addition, the materials have excellent durability, which is manifested as low erosiveness by data of a chloride ion corrosion test.

It can be seen from comparison between Example 1 in which an amount of the stone powder is 0 and Example 2 in which an amount of the stone powder is 50, a product of Example 1 has a lower strength than a product of Example 2, which may be caused by changes of chemical products generated from the stone powder and structures thereof. It can be seen from comparison between Example 3 and Example 4 that, a large amount of the fly ash can lead to a high strength. It can be seen from comparison between Example 5 and Example 6 that a large amount of the stone powder can lead to a poor strength. It can be seen from comparison between Example 7 and Example 8 that a slightly-large amount of the cement can make a product have a high strength. It can be seen from comparison between Example 9 and Example 10 that a small amount of the steel fiber can make a product have a low strength. In Example 11, because the fly ash and the stone powder are not added, the environmental safety of a product is not up to standard. Only when the cement and the phosphogypsum are added at optimal amounts, a sulfoaluminate hydrate generated has optimal expansibility. If the sulfoaluminate hydrate has too-high expansibility, a material will be destructed due to expansion. If the sulfoaluminate hydrate has too-low expansibility, cracks will be produced due to shrinkage.

Each of the raw materials used in the present disclosure is commercially available.

The objects, technical solutions, and beneficial effects of the present disclosure are further described in detail in the above specific embodiments. It should be understood that the above are merely specific embodiments of the present disclosure, and are not intended to limit the scope of the present disclosure. Any modification, equivalent replacement, or improvement made within the spirit and principle of the present disclosure shall fall within the scope of the present disclosure.

What is claimed is:

1. A phosphogypsum-based backfill material, comprising the following raw materials in parts by weight: 0.2-0.8 parts of water, 0.01-0.3 parts of a cement, 0.01-0.6 parts of a fly ash, 0-0.6 parts of a stone powder, 0-3 parts of a sand, and 0-5 parts of a stone; and
further comprising the following raw materials in parts by weight:
one part of any one or a combination of two or more selected from the group consisting of phosphogypsum, a modified phosphogypsum, and a modified phosphogypsum powder, and
0-0.5 parts of any one selected from the group consisting of a basalt fiber, graphite, and a steel fiber.

2. The phosphogypsum-based backfill material according to claim 1, wherein the basalt fiber, the graphite, or the steel fiber has a length of less than or equal to 50 mm.

3. The phosphogypsum-based backfill material according to claim 1, wherein a mass ratio of the water to (the cement+the modified phosphogypsum+the modified phosphogypsum powder) or a mass ratio of the water to (the cement+the fly ash+the stone powder) is less than or equal to 0.5.

4. The phosphogypsum-based backfill material according to claim 1, wherein a mass of the steel fiber or the basalt fiber is 10% to 20% of a mass of the phosphogypsum or the modified phosphogypsum, and a mass ratio of the fly ash to the cement is in a range of (1-3):1.

5. The phosphogypsum-based backfill material according to claim 1, wherein the cement is a portland cement.

6. The phosphogypsum-based backfill material according to claim 1, wherein a fineness degree and a specific surface area of the fly ash meet grade I and II requirements in a fly ash specification.

7. The phosphogypsum-based backfill material according to claim 1, wherein the stone powder has a particle size D90 of 25 μm to 150 μm.

8. A method for preparing the phosphogypsum-based backfill material according to claim 1, comprising the following steps:
adding the raw materials to a grout stirring device according to the formula, and thoroughly stirring.

9. The method according to claim 8, wherein the stirring is conducted for 1 min to 6 min at a rotational speed of 48 rpm.

10. The method according to claim 8, wherein the basalt fiber, the graphite, or the steel fiber has a length of less than or equal to 50 mm.

11. The method according to claim 8, wherein a mass ratio of the water to (the cement+the modified phosphogypsum+the modified phosphogypsum powder) or a mass ratio of the water to (the cement+the fly ash+the stone powder) is less than or equal to 0.5.

12. The method according to claim 8, wherein a mass of the steel fiber or the basalt fiber is 10% to 20% of a mass of the phosphogypsum or the modified phosphogypsum, and a mass ratio of the fly ash to the cement is in a range of (1-3):1.

13. The method according to claim 8, wherein the cement is a portland cement.

14. The method according to claim 8, wherein a fineness degree and a specific surface area of the fly ash meet grade I and II requirements in a fly ash specification.

15. The method according to claim 8, wherein the stone powder has a particle size D90 of 25 μm to 150 μm.
